(19) United States
(12) Patent Application Publication
(10) Pub. No.: US 2026/0349690 A1
(43) Pub. Date: Nov. 5, 2026

(54) MACHINE-LEARNING COMPILER CONFIGURED TO GENERATE USER-MODIFIABLE SOURCE CODE

(71) Applicants: ADVANCED MICRO DEVICES, INC., Santa Clara, CA (US); ATI TECHNOLOGIES ULC, Markham (CA)

(72) Inventors: Adam Pawel Sawicki, Warsaw (PL); Florian Herick, Bavaria (DE); Fabio Camaiora, Uppsala (SE); Ihor Nestor Szlachtycz, Markham (CA); Nadav Geva, Ayer, MA (US); Carl Johan Lejdfors, Limhamn (SE)

(21) Appl. No.: 19/197,541

(22) Filed: May 2, 2025

(51) Int. Cl. G06F 8/41

(52) U.S. Cl. CPC G06F 8/41

(57) ABSTRACT

To generate user-modifiable code for a machine-learning (ML) model, a system includes one or more processors that implement an ML compiler including one or more frontends that are configured to receive an ML file representing the ML model in one or more corresponding formats. In response to receiving an ML file, the ML compiler generates an intermediate representation of the ML model based on the context in which the ML model is to be deployed. The ML compiler then performs one or more optimization and transformation passes on the intermediate representation to produce a transformed representation of the ML model. From this transformed representation, the ML compiler generates user-modifiable source code for the ML model.

### BACKGROUND

Certain graphics applications implement a machine-learning (ML) model to help render game frames that are presented to a user. To facilitate the usage of an ML model, a processing system first trains the ML model using sets of training data and produces a trained ML model including one or more layers, operators, and tensors. Further, the processing system then modifies these layers, operators, and tensors of the trained ML model based on the processing units on which the trained ML model is to be deployed. From this modified ML model, the processing system generates executable code that these processing units use to perform one or more operations so as to implement the ML model. After performing these operations, the processing units store the resulting data which is then used by the application to render one or more game frames.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a block diagram of a compiling system implementing a machine-learning (ML) compiler configured to generate user-modifiable source code based on data representing an ML model, in accordance with some embodiments.

FIG. 2 is a flow diagram of an example process for the development and deployment of an ML model using an ML compiler configured to generate user-modifiable source code, in accordance with some embodiments.

FIG. 3 is a flow diagram of an example process for generating a transformed representation of an ML using an ML compiler configured to generate user-modifiable source code, in accordance with some embodiments.

FIG. 4 is a block diagram of an example processing system configured to implement an ML model based on machine-readable code generated from user-modifiable source code, in accordance with embodiments.

FIG. 5 is a flow diagram of an example method for generating user-modifiable source code that is used to implement an ML model, in accordance with some embodiments.

### DETAILED DESCRIPTION

Systems and techniques disclosed herein are directed toward an ML compiler configured to generate user-modifiable source code that is used to implement one or more ML models on a processing system. For example, certain processing systems are configured to execute applications (e.g., gaming applications, image generation applications, etc.) that implement one or more ML models such as supervised models, unsupervised models, reinforcement models, neural networks (recurrent neural networks, convolutional neural networks), large language models, multimedia large language models, natural language models, deep-learning models, federated learning models, or any combination thereof that help render one or more frames, generate images, or both. As an example, a processing system is configured to execute a gaming application that renders one or more primitives for a scene by implementing one or more ML models in a graphics pipeline for real-time rendering such as neural network ambient occlusion models, three-dimensional Gaussian Splatting models, and the like. As another example, a processing system is configured to execute an image generation application that renders an image by implementing one or more ML models in a graphics pipeline for offline (e.g., not real-time) rendering such as a large language model, multimedia large language model, or the like. To enable these ML models to be implemented for an application, the application includes machine-readable code, such as binary code, that represents the ML model. As an example, the application includes machine-readable code representing the architecture, operators, and tensors of the ML model. When the application is executed by a processing system, a driver executed by the processing system compiles the machine-readable code of the application into executable data and provides this executable data to a processing unit (e.g., acceleration unit (AU)) of the processing system. In response to receiving this executable data, the processing unit performs one or more operations for the ML model based on the executable data and stores data resulting from the performance of the operations in the memory of the processing system. As an example, while executing a gaming application, the processing unit performs one or more operations for an ML model in a graphics pipeline so as to produce data used to render one or more primitives of a scene.

To generate this machine-readable code representing an ML model, a compiling system includes one or more processors that implement an ML compiler configured to generate user-modifiable source code representing the ML model. As an example, the ML compiler is configured to receive one or more machine-learning files that include data representing the architecture, weights, or both of an ML model to be implemented by an application. Further, each of these machine-learning files, for example, has a corresponding format (e.g., Open Neural Network Exchange (ONNX) format) that indicates the type, arrangement, syntax, and the like of the data included in the ML file. To support one or more formats for ML files, the ML compiler includes one or more frontends each configured to receive an ML file having a corresponding format. In response to receiving an ML file having a corresponding format, a frontend of the ML compiler generates an intermediate representation of the ML model indicated by the ML file. That is to say, the frontend generates an intermediate representation of the ML model based on the architecture and weights indicated in the ML file. This intermediate representation, for example, indicates one or more operators to be performed for the machine-learning model such as matrix operations, addition operations, subtraction operations, multiplication operations, division operations, activation functions, element-wise operations, convolution operations, pooling operations, and the like. Further, the intermediate operation indicates one or more tensors provided as inputs, generated as outputs, used as constants by, pass between, or any combination thereof these operators.

After a frontend generates an intermediate representation of an ML model, the ML compiler performs one or more optimization and transformation passes to produce a transformed representation of the ML model. That is to say, the ML compiler modifies (e.g., changes, adds, removes, or any combination thereof) one or more operators, tensors, or both of the intermediate representation. For example, these optimization and transformation passes include transforming one or more data types used by operators indicated in an intermediate representation, fusing two or more operators indicated in the intermediate representation, or both so as to reduce the memory footprint when implementing a corresponding ML model, reduce memory accesses by a corresponding ML model, reduce the processing time needed to implement a corresponding ML model, reduce the processing resources needed to implement a corresponding ML model, improve memory access patterns of a corresponding ML model, reduce memory latency for a corresponding ML model, or any combination thereof. As another example, the optimization and transformation passes include transforming one or more data types used by operators indicated in an intermediate representation, fusing two or more operators indicated in the intermediate representation, or both so as to reduce the memory footprint when implementing a corresponding ML model, reduce memory accesses by a corresponding ML model, reduce the processing time needed to implement a corresponding ML model, reduce the processing resources needed to implement a corresponding ML model, improve memory access patterns of a corresponding ML model, reduce memory latency for a corresponding ML model, or any combination thereof when a specific processing unit (e.g., AU) implements the corresponding ML model. That is say, the optimization and transformation passes modify (e.g., change, add, remove) the operators, tensors, or both of the intermediate representation based on the hardware of one or more certain processing units. Further, after modifying one or more operators, tensors, or both of the intermediate representation, the ML compiler performs one or more memory allocation operations to allocate memory to the tensors of the modified operators such as initializer buffers (e.g., buffers configured to hold parameters of a corresponding ML model, such as weights or biases), scratch buffers (e.g., buffers configured to hold intermediate tensors passed between operations of a corresponding ML model), and the like. After performing these memory allocation operations, the ML compiler produces a transformed representation of the ML model. Additionally, under certain circumstances, the ML model is configured to further generate the intermediate representation, transformed representation, or both based on the context in which the ML model is to be implemented. For example, the ML model is configured to generate the intermediate representation, modify the intermediate representation so as to produce the transformed representation, or both based on whether the ML model is to be implemented in a real-time graphics context (e.g., for a real-time graphics application) or offline graphics context (e.g., for offline graphics applications).

After producing a transformed representation of the ML model, the ML compiler provides the transformed representation to one or more backends each configured to generate user-modifiable source code based on the transformed representation. This user-modifiable source code, for example, includes high-level source code representing a corresponding ML model that is able to be read, modified, or both by one or more human users. That is say, each backend of the ML compiler is configured to generate source code for an ML model that is readable and modifiable (e.g., editable) by one or more human users. Further, each backend of the ML compiler is configured to generate such user-modifiable source code in a corresponding language supported by the ML compiler. Such a language of the user-modifiable source code, for example, indicates the type, arrangement, syntax, and the like of the data indicated in the user-modifiable source code. As an example, a backend of the ML compiler generates user-modifiable source code in a high-level shader language (HLSL). After user-modifiable source code for an ML model is produced by the ML compiler, one or more users edit the user-modifiable source code, or both, one or more compilers compile the user-modifiable source code into machine-readable code to be included in an application. In this way, the ML compiler of the compiling system is configured to generate user-modifiable source code representing an ML model that is used to generate machine-learning source code to be included in an application. By producing such user-modifiable source code, the ML compiler allows one or more users to edit the user-modifiable source code before the corresponding machine-readable code is included in an application. As an example, users are enabled to modify the user-modifiable source code based on different contexts, known errors, performance characteristics, the hardware on which the corresponding ML will be implemented, interoperability with other applications (e.g., other shader applications), or any combination thereof. As such, by providing user-modifiable source code, the ML compiler provides more versatility when compared to other typical ML compilers that, for example, generate opaque, executable data (e.g., executable data unreviewable by a user) directly from data representing an ML model (e.g., executable data.

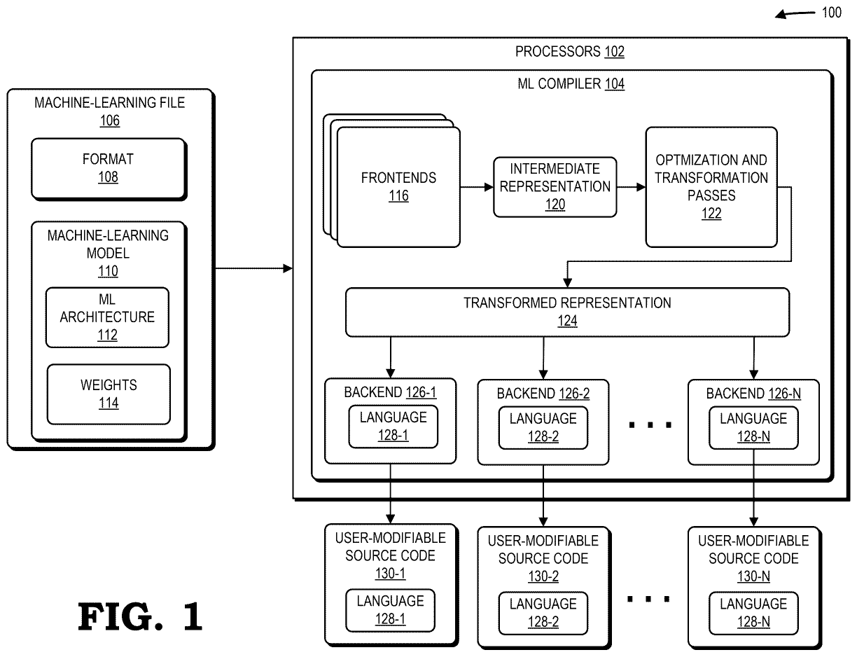

Referring now to FIG. 1, a compiling system 100 implementing an ML compiler configured to generate user-modifiable source code based on data representing an ML model is presented, in accordance with embodiments. In embodiments, compiling system 100 includes one or more processors 102 (e.g., one or more central processing units (CPUs), AUs, or both) configured to implement ML compiler 104. As an example, processors 102 are configured to execute code (e.g., executable binary code) that implements ML compiler 104. According to embodiments, ML compiler 104 is configured to generate user-modifiable source code 130 for one or more ML models 110 to be included in one or more applications having one or more contexts such as real-time graphics generation, offline image generation, gaming calculations (e.g., physics calculations, lighting calculations), or any combination thereof—to name a few. As an example, ML compiler 104 is configured to generate user-modifiable source code 130 for one or more ML models 110 to be used for real-time shader operations in a gaming application. Such user-modifiable source code 130, for example, includes code that is able to be read, modified (e.g., edited), or both by one or more human users. Further, such user-modifiable source code 130 is configured to be compiled by one or more compilers so as to generate machine-readable code that is included in one or more applications so that these applications include the ML model 110 associated with the user-modifiable source code 130. As an example, some user-modifiable source code 130 generated by ML compiler 104 is configured to be compiled by one or more shader compilers so as to generate machine-readable shader code included in a gaming application that includes the ML model 110 associated with the user-modifiable source code 130.

To generate such user-modifiable source code 130, ML compiler 104 includes one or more frontends 116 configured to receive an ML file 106 representing a corresponding ML model 110. Such ML models 110, for example, include supervised models, unsupervised models, reinforcement models, neural networks (recurrent neural networks, convolutional neural networks), large language models, multimedia large language models, natural language models, deep-learning models, federated learning models, or any combination thereof—to name a few. Further, an ML file 106 includes data in a corresponding format 108 indicating the ML architecture 112 and weights 114 of a corresponding ML model 110. Within an ML file 106, the data representing the ML architecture 112 of an ML model 110 indicates the structure, design, or the like of one or more components of the ML model 110 such as one or more layers, nodes, processing steps, data flows, feature extractions, and the like. Additionally, the format 108 of an ML file 106 is a data format (e.g., binary file format) that indicates the type, arrangement, syntax, and the like of the data included in the ML file 106. As an example, the format 108 of an ML file 106 is an open neural network exchange file format (ONNX file format), Hierarchical Data Format (HDF), or the like. According to embodiments, ML compiler 104 includes one or more frontends 116 each configured to receive ML files 106 having a corresponding format 108. As an example, ML compiler 104 includes a first frontend configured to receive (e.g., supporting) ML files 108 having a first format and a second frontend configured to receive ML files having a second format different from the first format. In this way, ML compiler 104 is configured to support ML files 106 having different formats 108.

In response to receiving an ML file 106 indicating an ML model 110, a frontend 116 of ML compiler 104 is configured to generate an intermediate representation 120 of the ML model 110 based on the ML architecture 112, weights 114, or both indicated in the ML file 106. This intermediate representation 120, for example, indicates a structure (e.g., data flow) of one or more operators to be performed for the ML model 110 and one or more tensors provided as inputs for, generated as outputs by, used as constants for, pass between, or any combination thereof for these operators. Such operators to be performed for an ML model 110 include, for example, one or more matrix operations (e.g., transpose operations, dot-product operations, inversion operations), addition operations, subtraction operations, multiplication operations, division operations, activation functions, element-wise operations, convolution operations, pooling operations, and the like. Further, the intermediate representation 120 includes data defining the tensors associated with the operators such as data defining the shape (e.g., number of elements per dimension) of, data types used by, ordering of the dimensions of, padding used by, work distribution of, or any combination thereof of one or more tensors. According to some embodiments, a frontend 116 is further configured to generate an intermediate representation 120 of an ML model 110 based on the context in which the ML model 110 is to be implemented. That is to say, a frontend 116 is further configured to generate an intermediate representation 120 of an ML model 110 based on whether the ML model 110 is to be implemented in a real-time graphics context (e.g., as for gaming applications), an offline graphics context (e.g., as for image generation applications), gaming calculation context, or any combination thereof—to name a few. For example, a frontend 116 is configured to determine one or more operators, structures (e.g., data flows) for operators, tensors associated with the operators, or any combination thereof. The frontend 116 then includes these determined operators, structures, tensors, or any combination thereof in an intermediate representation 120 of the ML model 110.

After an intermediate representation 120 of an ML model 110 is generated, ML compiler 104 (e.g., the processors 102 implementing ML compiler 104) performs one or more optimization and transformation passes 122 to generate a transformed representation 124 based on the intermediate representation 120, the context in which the ML model 110 is to be implemented, or both. For example, during these optimization and transformation passes 122, ML compiler 104 modifies (e.g., changes, adds, removes, or any combination thereof) one or more operators, modifies one or more tensors associated with the operators (e.g., reorders one or more tensors), fuses one or more operators, or any combination thereof indicated in the intermediate representation 120 so as to reduce the memory footprint of, reduce memory accesses by, reduce the processing time of, reduce the processing resources used by, improve memory access patterns of, reduce memory latency of, or any combination thereof the ML model 110 when it is implemented by a corresponding processing system (e.g., when the application including the ML model 110 is executed by the processing system). In some embodiments, ML compiler 104 is configured to modify (e.g., change, add, remove, or any combination thereof) one or more operators, modify one or more tensors associated with the operators (e.g., modify the order of one or more tensors), fuse one or more operators, or any combination thereof indicated in an intermediate representation 120 based on the hardware of a corresponding processing system (e.g., a corresponding AU). As an example, ML compiler 120 modifies an intermediate representation 120 so as to reduce the memory footprint of, reduce memory accesses by, reduce the processing time of, reduce the processing resources used by, improve memory access patterns of, reduce memory latency of or any combination thereof the ML model 110 when it is implemented by the hardware of a corresponding processing system. Additionally, according to some embodiments, ML compiler 104 is configured to modify (e.g., change, add, remove, or any combination thereof) one or more operators, modify one or more tensors associated with the operators, fuse one or more operators, or any combination thereof indicated in an intermediate representation 120 based on the context in which the ML model 110 is to be implemented. For example, ML compiler 104 modifies an intermediate representation 120 so as to reduce the memory footprint of, reduce memory accesses by, reduce the processing time of, reduce the processing resources used by, improve memory access patterns of, reduce memory latency of, or any combination thereof the ML model 110 when it is implemented in a corresponding context (e.g., real-time graphics rendering context, offline graphics rendering context, gaming calculation context).

After modifying one or more operators, modifying or more tensors (e.g., reordering one or more tensors), fusing two or more operators, or any combination thereof indicated in an intermediate representation 120, ML compiler 104 allocates memory to the tensors (e.g., data of the tensors) used by one or more of the operators such as one or more initializer buffers, scratch buffers, or the like. ML compiler 104 then, after modifying the intermediate representation 120, allocating memory to the intermediate representation 120, or both, produces a transformed representation 124 of the ML model 110. From this transformed representation 124 of the ML model 110, ML compiler 104 is configured to generate user-modifiable source code 130 in one or more languages 128 (e.g., coding languages) that represents the ML model 110. That is to say, ML model 110 generates source code enabled to be read, modified, or both by one or more human users in one or more languages 128 based on the transformed representation 124. These languages 128, for example, each represent a corresponding computer coding language that indicates the type, arrangement, syntax, and the like of the data indicated in the user-modifiable source code 130. As an example, such languages 128 include high-level shader language (HLSL), C, C++, OpenGL Shading language (GLSL), heterogeneous-computing interface for portability (HIP), or the like. According to embodiments, ML compiler 104 includes one or more backends 126 each configured to generate user-modifiable source code 130 is a corresponding language 128. For example, ML compiler 104 includes a first backend 126-1 configured to generate user-modifiable source code 130-1 in a first language 128-1 (e.g., HLSL) and a second backend 126-2 configured to generate user-modifiable source code 130-2 in a second language 128-2. Though the example embodiment presented in FIG. 1 shows ML compiler 104 as including three backends (126-1, 126-2, 126-N) representing an N integer number of backends (where N>0) each configured to generate user-modifiable source code (130-1, 130-2, 130-N) in a corresponding language (128-1, 128-2, 128-N), in other embodiments, ML compiler 104 can include any non-zero integer number of backends 126 each configured to generate user-modifiable source code 130 in a corresponding language 128.

According to embodiments, after a backend generates user-modifiable source code 130, compiling system 100 provides the user-modifiable source code 130 to one or more compilers configured to generate machine-readable code (e.g., binary source code) representing the ML model 110 associated with the user-modifiable source code 130. As an example, for user-modifiable source code 130 in HLSL representing an ML model 110 that is to be implemented for real-time graphics renderings (e.g., for a gaming application), compiling system 100 provides the user-modifiable source code 130 to one or more shader compilers configured to generate machine-readable code (e.g., machine-readable shader code) representing the ML model 110 based on the user-modifiable source code 130. In embodiments, such machine-readable code generated from the user-modifiable source code 130 is then implemented in one or more applications to be executed by a processing system such that the ML model 110 associated with the machine-readable code is implemented when the application is executed. In this way, ML compiler 104 is configured to generate user-modifiable source code 130 in one or more languages 128 (e.g., one or more coding languages) for an ML model 110 based on data representing the ML model 110. Because ML compiler 104 is configured to generate user-modifiable source code 130 that is able to be read and modified by one or more users (e.g., human users), such users are enabled to read, understand, and modify the user-modifiable source code 130 before the user-modifiable source code 130 is compiled into machine-readable code. As an example, these users are enabled to edit the user-modifiable source code 130 based on different contexts, known errors, the hardware on which a corresponding ML model 110 will be implemented, interoperability with other applications (e.g., other shader applications), or any combination thereof so to improve the performance of the ML model 110 represented by the user-modifiable source code 130. Further, due to this ability to be modified, the user-modifiable source code 130 is able to be adapted to other contexts, increasing the versatility of the code generated by ML compiler 104 for an ML model 110 when compared to the executable data generated by other ML compilers for an ML model 110.

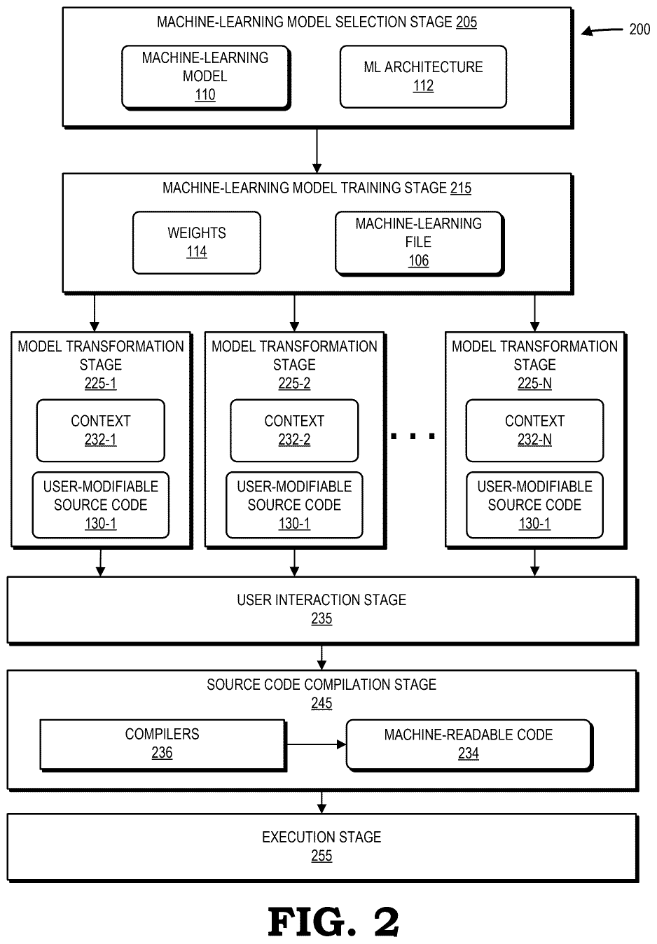

Referring now to FIG. 2, an example process 200 for the development and deployment of an ML model using an ML compiler configured to generate user-modifiable source code is presented, in accordance with embodiments. In embodiments, example process 200 includes the development and deployment of an ML model 110 using ML compiler 104. For example, at block 205 of example process 200, an ML model selection system is configured to select an ML model 110 to be deployed. For example, the ML model selection system selects an ML model 110 having a corresponding ML architecture 112 based on one or more applications into which the ML model is to be implemented, one or more contexts 232 (e.g., real-time graphics rendering, offline graphics rendering) into which the ML model 110 is to be implemented, one or more functions that are to be performed by the ML model 110, or any combination thereof. In embodiments, such an ML selection system includes one or more computing devices (e.g., personal computers, personal mobile devices, servers) having one or more processors. After an ML model 110 having a corresponding ML architecture 112 has been selected, at block 215, example process 200 includes the ML selection system training the ML model 110 based on corresponding training data. Such training data, for example, indicates one or more patterns, relations, structures, or any combination thereof that dictate the behavior (e.g., the analysis and inferences) of the ML model 110. According to embodiments, training the ML model 110 based on the training data produces the weights 114 of the ML model 110 which define how the ML model 110 transforms provided inputs to desired outputs. Further, still referring to block 215, after training the ML model 110, the ML selection system is configured to generate an ML file 106 representing the ML model 110 (e.g., an ML file 106 that indicates the ML architecture 112 and weights 114 of the ML model 110). In embodiments, the ML selection system is configured to generate the ML file 106 in a format 108 supported by a frontend 116 of ML compiler 104. As an example, the ML selection system generates the ML file 106 in an ONNX file format.

After an ML file 106 is generated, example process 200 includes implementing one or more model transformation stages 225. During each of these model transformation stages 225, ML compiler 104 is configured to generate user-modifiable source code 130 from the ML file 106 based on a corresponding context 232 into which the ML model 110 indicated by the ML file 106 will be implemented. These contexts 232, for example, include real-time graphics rendering (e.g., for gaming applications), offline graphics rendering (e.g., for image generation applications), gaming calculations (e.g., physics computations), or the like. For example, each model transformation stage 225 includes ML compiler 104 generating an intermediate representation 120, transformed representation 124, or both of the ML model 110 based on a corresponding context 232 so as to allow the ML model 110 to generate desired outputs for the context 232, improve performance of the ML model 110 for the context 232, or both. After generating an intermediate representation 120, transformed representation 124, or both based on a corresponding context 232, a model transformation stage 225 includes ML compiler 104 generating user-modifiable source code 130 for that context 232. As an example, ML compiler 104 generates user-modifiable source code 130 for a real-time graphics context. Though the example embodiment presented in FIG. 2 shows example process 200 as including three model transformation stages (225-1, 225-2, 255-N) representing an N integer number of model transformation stages (where N>0) each associated with a corresponding context (232-1, 232-2, 232-N), in other embodiments, example process 200 includes any number of model transformation stages 225 each associated with a corresponding context 232.

In embodiments, example process 200 includes, a user interaction stage 235 after user-modifiable source code 130 representing the ML model 110 has been generated during one or more model transformation stages 225. This user interaction stage, for example, includes one or more users reading, modifying, or both user-modifiable source code 130. For example, the user interaction stage includes one or more users modifying user-modifiable source code 130 so as to adapt user-modifiable source code to one or more other contexts 232 (e.g., another context 232 not associated with user-modifiable source code 130), correct one or more errors, improve the performance of the ML model 110 on certain hardware, enable interoperability of the ML model 110 with other applications, or any combination thereof. Further, according to embodiments, example process 200 includes, at block 245, a source code compilation stage during which one or more compilers 236 compile user-modifiable source code 130 generated during a model transformation stage 225, as modified by user interaction stage 235, or both into machine-readable code 234 representing the ML model 110. Such compilers 236, include one or more processors running a compiler (e.g., shader compiler) configured to compile the user-modifiable source code 130 into machine-readable code 234 interpretable by a processing system (e.g., by a driver executed by the processing system). As an example, a compiler 236 is configured to compile user-modifiable source code 130 in HLSL into machine-readable code 234 (e.g., binary code) in HLSL representing the ML model 110. After generating such machine-readable code 234, the machine-readable code 234 is included in an application so that when the application is executed, the ML model 110 represented by the machine-readable code 234 is implemented. For example, at block 255, during an execution stage, an application including machine-readable code 234 is executed by a processing system including one or more CPUs and one or more AUs. When executing the application, a driver executed by a CPU of the processing system generates AU-executable data (e.g., data able to be executed by the AU) that represents the ML model 110 based on the machine-readable code 234. This driver then provides the AU-executable data to the AU of the processing system which then performs one or more operations so as to implement the ML model 110.

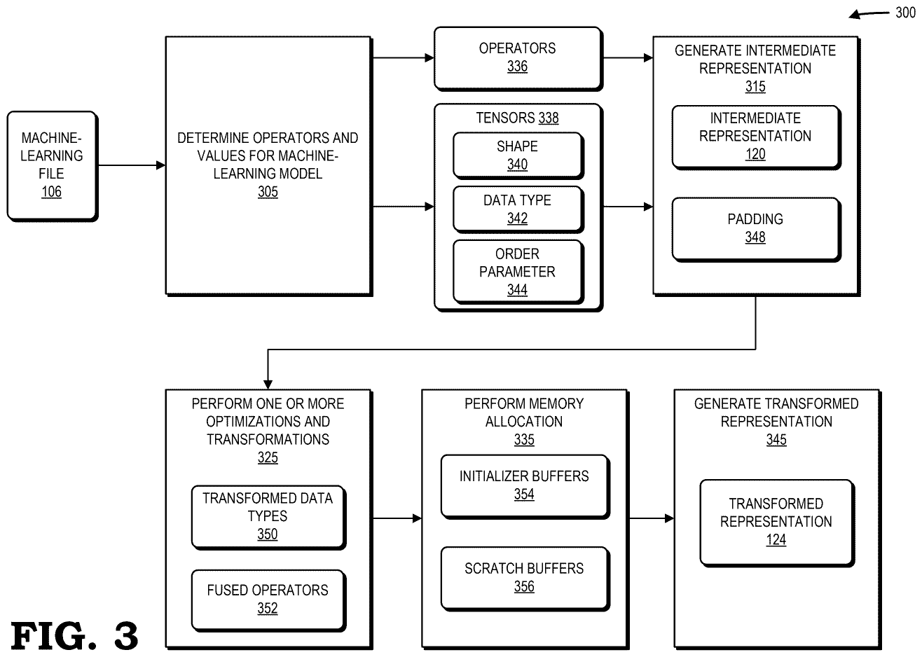

Referring now to FIG. 3, an example process 300 for generating a transformed representation of an ML model using an ML compiler configured to generate user-modifiable source code is presented, in accordance with some embodiments. In embodiments, example process 300 is implemented at least in part by ML compiler 104 (e.g., one or more processors 102 executing ML compiler 104). Example process 300 includes, at block 305, determining one or more operators 336 and tensors 338 for an ML model 110 based on an ML file 106 representing that ML model 110. As an example, a frontend 116 of ML compiler 104 is configured to parse an ML file 106 and determine one or more operators 336, tensors 338, or both of an ML model 110 based on the ML architecture 112, weights 114, or both indicated in the ML file 106. Such operators 336 of an ML model 110, for example, include one or more matrix operations (e.g., transpose operations, dot-product operations, inversion operations), addition operations, subtraction operations, multiplication operations, division operations, activation functions, element-wise operations, convolution operations, pooling operations, and the like. Further, in some embodiments, one or more operators 336 are in a format (e.g., transaction binary format) so that the operator 336 is defined by an input, output, buffer ordering for intermediate outputs, and offsets for buffer addresses (e.g., buffer offsets). Further, such tensors 338 are provided as an input to one or more operators 336, generated as an output by one or more operators 336, used as a constant by one or more operators 336, passed as temporary data between operators 336, or any combination thereof. According to embodiments, such tensors 338 are defined by one or more shapes 340, data types 342, order parameters 344, or any combination thereof. A shape 340, for example, indicates the number of elements per dimension of a tensor 338. Further, data types 342 indicate the data types used for inputs, outputs, or both of a tensor 338. Additionally, an order parameter 344 indicates an ordering for the axes of one or more tensor 338 such as indexing samples in a batch, indexing channels, indexing rows (e.g., indexing rows of an image), indexing columns (e.g., indexing columns of an image), or any combination thereof.

After determining one or more operators 336, one or more tensors 338 (e.g., tensors 338 associated with the operators 336), or both, example process 300 includes, at block 315, ML compiler 104 generating an intermediate representation 120 of the ML model 110 that includes the determined operators 336 and tensors 338. For example, the intermediate representation 120 indicates a data flow (e.g., structure) for the operators 336 and one or more tensors 338 associated with the operators 336. Further, in some embodiments, at block 315, ML compiler 104 is configured to insert padding 348 into one or more tensors 338 indicated in the intermediate representation 120. Such padding 348, for example, includes data (e.g., bits) representing a number of extra elements added before the first row, before the first column, after the last row, after the last column, or another combination thereof of one or more corresponding tensors 338. At block 325, ML compiler 104 is configured to perform one or more optimization passes, transformation passes, or both using the intermediate representation 120. For example, ML compiler 104 modifies (e.g., changes, adds, removes, or any combination thereof) one or more operators 336, modifies one or more tensors 338 associated with the operators 336 (e.g., reorders one or more tensors 338), fuses two or more operators 336, or any combination thereof indicated in the intermediate representation 120 so as to reduce the memory footprint of, reduce memory accesses by, reduce the processing time of, reduce the processing resources used by, improve memory access patterns of, reduce memory access latencies for, or any combination thereof the ML model 110 when it is implemented by a corresponding processing system (e.g., when the application including the ML model 110 is executed by the processing system).

In embodiments, ML compiler 104 modifies one or more data types used by one or more operators 336, tensors 338, or both so as to produce one or more transformed data types 350. Such transformed data types 350 include, for example, integer data types (e.g., int8, int16), floating point data types (e.g., fp8, fp16), or both. As an example, ML compiler 104 modifies one or more data types used by one or more operators 336, tensors 338, or both to smaller quantized data types so as to reduce the processing resources used by, the memory bandwidth required by, or both the ML model 110 when it is implemented by a corresponding processing system. According to some embodiments, ML compiler 104 fuses two or more operators 336 of the intermediate representation 120 to produce one or more fused operators 352 so as to reduce the processing resources needed by, the processing time of, the memory bandwidth of, or any combination thereof the ML model 110 when it is implemented by a corresponding processing system. After modifying (e.g., changing, adding, removing, or any combination thereof) one or more operators 336, modifying one or more tensors 338, fusing two or more operators 336, or any combination thereof of intermediate representation 120, at block 335, example process 300 includes ML compiler 104 allocating memory to the tensors 338 of the operators 336 of intermediate representation 120 (e.g., as modified at block 325). For example, ML compiler 104 allocates one or more initializer buffers 354, scratch buffers 356, or both to one or more tensors 338 of the operators 336 of the intermediate representation 120 as modified at block 325. At block 345, ML compiler 104 generates a transformed representation 124 based on the modifications of the intermediate representation 120, the memory allocated to the intermediate representation 120, or both. That is to say, ML compiler 104 generates a transformed representation 124 based on the modifications to the operators 336 of the intermediate representation 120, the modifications to tensors 338 of the intermediate representation 120, memory allocated to the intermediate representation 120, or any combination thereof. In embodiments, the resulting transformed representation 124 indicates one or more transformed data types 350, fused operators 352, initializer buffers 354, scratch buffers 356, or any combination thereof.

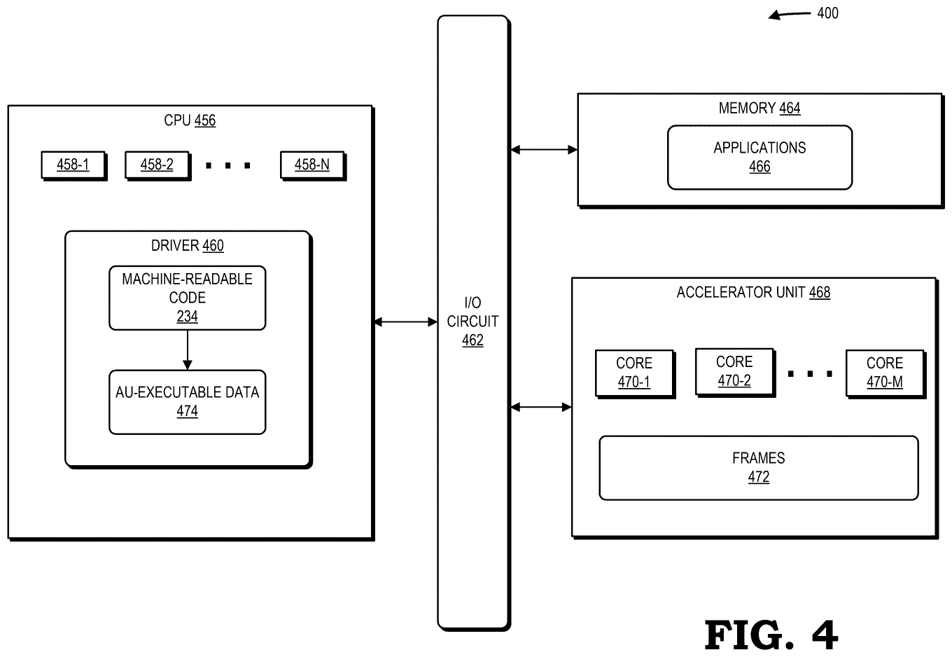

Referring now to FIG. 4, an example processing system 400 configured to implement an ML model based on machine-readable code generated from user-modifiable source code is presented, in accordance with some embodiments. In implementations, example processing system 400 is implemented within one or more servers, cloud-based devices, personal computers, laptops, drones, mobile devices, or the like and includes or has access to memory 464 or other storage components implemented using a non-transitory computer-readable medium, for example, a dynamic random-access memory (DRAM). In some implementations, memory 464 is implemented using other types of memory including, for example, static random-access memory (SRAM), nonvolatile RAM, and the like. Further, memory 464, according to some implementations, includes an external memory to the example processing system 400. The example processing system 400 also includes an I/O circuit 462 to support communication between one or more components (e.g., CPU 456, AU 468, memory 464) of the example processing system 400. I/O circuit 462 includes, for example, one or more busses, switches (e.g., PCI switches), data fabrics, queues, buffers, or the like. As an example, in implementations, I/O circuit 462 is configured to connect one or more processor cores 470 of AU 468 to one or more processor cores 458 of CPU 456.

According to embodiments, example processing system 400 is configured to execute one or more applications 466 configured to implement an ML model 110 when executed. For example, example processing system 400 executes one or more gaming applications to generate one or more frames 472. As another example, example processing system 400 executes one or more image generation applications. To implement the ML model 110 when executed, these applications 466 include machine-readable code 234 representing the ML model 110. This machine-readable code 234 is generated by one or more compilers 236 based on user-modifiable source code 130 generated by ML compiler 104. As an example, these compilers 236 compile user-modifiable source code 130 as modified by a user interaction stage 235 of example process 200 to produce machine-readable code 234. In embodiments, CPU 456 of example processing system 400 is configured to execute a driver 460 (e.g., AU driver) configured to generate AU-executable data 474 based on machine-readable code 234. Such AU-executable data 474, for example, indicates one or more operations to be performed by AU 468 so as to implement at least a portion of the ML model 110. To execute driver 460, CPU 456 includes one or more processor cores 458 that execute instructions, operations, or both for one or more applications 466, driver 460, or both. After generating AU-executable data 474, CPU 456 provides the AU-executable data 474 to AU 468 via, for example, I/O circuit 462. Though the example embodiment presented in FIG. 4 shows CPU 456 as including three processor cores (458-1, 458-2, 458-N) representing an N integer number of processor cores (where N>0), in other embodiment, CPU 456 can include any non-zero integer number of processor cores.

In response to receiving AU-executable data 474, AU 468 performs one or more operations indicated in AU-executable data 474 so as to implement at least a portion of ML model 110. To perform these operations, AU 468 includes one or more processor cores 470 each operating as one or more compute units (e.g., sets of single instruction, multiple data (SIMD) units) that perform the same operation for different data sets. As an example, AU 468 is implemented as one or more vector processors, coprocessors, graphics processing units (GPUs), general-purpose GPUs, neural processing units, non-scalar processors, highly parallel processors, AI processors, inference engines, machine-learning processors, other multithreaded processing units, scalar processors, serial processors, programmable logic devices (e.g., field-programmable logic devices), or any combination thereof. Though the example implementation presented in FIG. 4 shows AU 468 as including three processor cores (470-1, 470-2, 470-M) representing an M integer number of processor cores (where M>0), in other implementations, AU 468 may include any non-zero integer number of processor cores 470. After performing one or more operations indicated in AU-executable data 474, a processor core 470 of AU 468 stores the data resulting from the performance of the operation (e.g., results) in memory 464. These results, in embodiments, are then used by the application 466 being executed by example processing system 400. As an example, an application 466 (e.g., gaming application) being executed uses such results to generate one or more frames 472 to be presented. In this way, example processing system 400 is configured to implement an ML model 110 based on machine-readable code 234 generated from user-modifiable source code 130 from ML compiler 104.

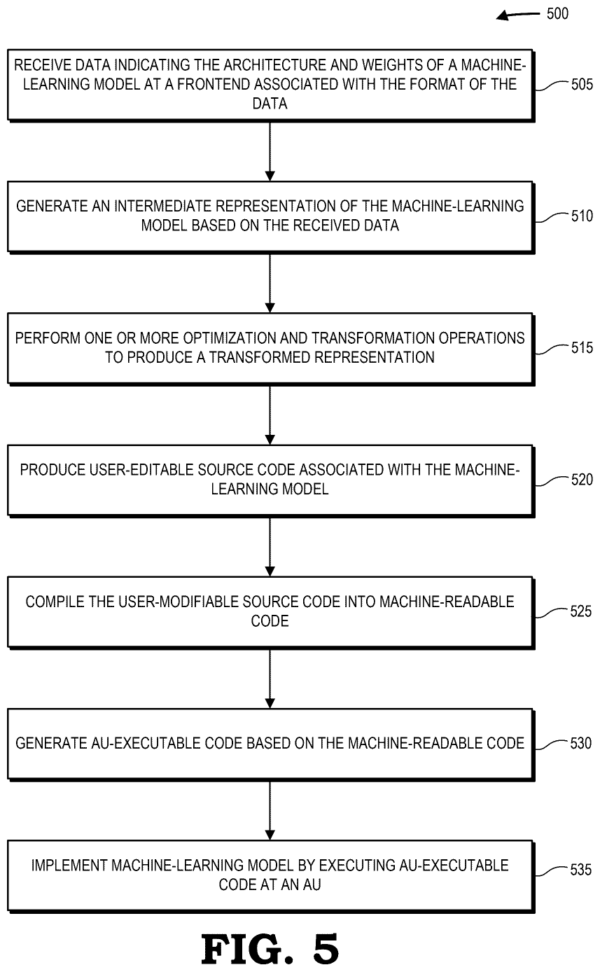

Referring now to FIG. 5, an example method 500 for generating user-editable source code used to implement an ML model is presented, in accordance with embodiments. In embodiments, at least a portion of example method 500 is implemented at least in part by ML compiler 104 (e.g., one or more processors 102 implementing ML compiler 104). Example method 500 includes, at block 505, ML compiler 104 receiving an ML file 106 associated with an ML model 110. As an example, the ML file 106 includes data indicating the ML architecture 112, weights 114, or both of the ML model 110. Further, the ML file 106 has a format 108 (e.g., data format) indicating the type, arrangement, syntax, and the like of the data included in the ML file 106. As an example, the ML file 106 has an ONNX file format. According to embodiments, ML compiler 104 is configured to receive the ML file 106 at a frontend 116 associated with (e.g., supporting) the format 108 of the ML file 106. That is to say, the frontend 116 corresponding to the format of the ML file 106 is configured to receive the ML file 106. At block 510, the frontend 116 that received the ML file 106 configured to generate an intermediate representation 120 of the ML model 110 based on the ML architecture 112 indicated in the ML file 106, the weights 114 indicated in the ML file, a context 232 in which the ML model 110 is to be implemented, or any combination thereof. For example, frontend 116 parses the ML file 106 to determine one or more operators 336, tensors 338, or both of the ML model 110 based on the ML architecture 112 indicated in the ML file 106, the weights 114 indicated in the ML file, a context 232 in which the ML model 110 is to be implemented, or any combination thereof. The frontend 116 then generates an intermediate representation 120 of the ML model 110 including these operators 336 and tensors 338.

After generating the intermediate representation 120, ML compiler 104, at block 515, performs one or more optimization passes, transformation passes, or both to produce a transformed representation 124. As an example, ML compiler 104 modifies (e.g., changes, adds, removes, or any combination thereof) one or more operators 336, modifies one or more tensors 338 associated with the operators 336 (e.g., reorders one or more tensors 338), fuses one or more operators 336; or any combination thereof indicated in the intermediate representation 120 so as to reduce the memory footprint of, reduce memory accesses by, reduce the processing time of, reduce the processing resources used by, improve the memory access patterns of, reduce the memory access latencies of, or any combination thereof the ML model 110 when it is implemented by a corresponding processing system, implemented in a certain context 232, or both. After modifying (e.g., changing, adding, removing, or any combination thereof) one or more operators 336, modifying one or more tensors 338, or both indicated in the intermediate representation 120, ML compiler 104 allocates memory to the operators 336, tensors 338, or both indicated in the intermediate representation 120. ML compiler 104 then generates a transformed representation 124 based on the modified operators 336 of the intermediate representation 120, modified tensors 338 of the intermediate representation 120, fused operators 352, memory allocations, work distribution schemes, or any combination thereof. At block 520, ML compiler 104 generates user-modifiable source code 130 based on the transformed representation 124. For example, ML compiler 104 generates user-modifiable source code 130 representing the ML model 110 (e.g., structure, operators 336, tensors 338 of the ML model 110) as indicated by the transformed representation 124. Further, ML compiler 104 is configured to generate this user-modifiable source code 130 in one or more languages 128 (e.g., compute languages). For example, ML compiler 104 includes one or more backends 126 each configured to generate user-modifiable source code 130 in a corresponding language 128 based on a transformed representation 124. As an example, a backend 126 of ML compiler 104 is configured to generate user-modifiable source code 130 in HLSL.

At block 525, one or more compilers 236 are configured to compile user-modifiable source code 130 into machine-readable code 234 representing the ML model 110 (e.g., the ML model 110 indicated by the user-modifiable source code 130). Further, at block 530, the resulting machine-readable code 234 is included in one or more applications 466. At block 530, a processing system (e.g., example processing system 400) executes the application 466 and a driver 460 executed by a CPU 456 of the processing system generates AU-executable data 474 based on the machine-readable code 234 included in the application 466. Such AU-executable data 474, for example, indicates one or more operations to be performed so as to implement at least a portion of the ML model 110 represented by the machine-readable code 234. After generating this AU-executable data 474, at block 535, an AU 468 (e.g., one or more processor cores 470 of the AU 468) of the processing system performs the operations indicated in the AU-executable data 474 so as to implement at least a portion of the ML model 110. The AU 468 then stores data resulting from the performance of the operations in a memory 464 of the processing system.

In some embodiments, the apparatus and techniques described above are implemented in a system including one or more integrated circuit (IC) devices (also referred to as integrated circuit packages or microchips), such as the processors 102 described above with reference to FIGS. 1-5. Electronic design automation (EDA) and computer-aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer-readable storage medium accessible to the computing system. Likewise, the code representative of one or more phases of the design or fabrication of an IC device may be stored in and accessed from the same computer readable storage medium or a different computer readable storage medium.

A computer-readable storage medium may include any non-transitory storage medium, or combination of non-transitory storage media, accessible by a computer system during use to provide instructions and/or data to the computer system. Such storage media can include but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM) or other non-volatile memory device or devices, and the like. The executable instructions stored on the non-transitory computer-readable storage medium may be in source code, assembly language code, object code, or another instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A system, comprising:
one or more processors configured to implement a machine-learning (ML) compiler, wherein the one or more processors are configured to:
in response to receiving data indicating an ML model, generate an intermediate representation of the ML model based on a context in which the ML model is to be deployed;
modify one or more operators of the intermediate representation to produce a transformed representation; and
generate user-modifiable source code representing the ML model based on the transformed representation.

2. The system of claim 1, wherein the context includes real-time graphics rendering.

3. The system of claim 2, wherein the user-modifiable source code is in a high-level shader language.

4. The system of claim 1, wherein the one or more processors are configured to:
determine a plurality of operators and a plurality of tensors based on the data indicating the ML model, wherein the intermediate representation of the ML model indicates the plurality of operators and the plurality of tensors.

5. The system of claim 1, wherein the ML compiler is configured to receive the data indicating the ML model in an open neural network exchange (ONNX) file format.

6. The system of claim 1, wherein the one or more processors are configured to generate the user-modifiable source code representing the ML model in a coding language of a plurality of coding languages supported by the ML model.

7. The system of claim 1, wherein the one or more processors are configured to generate a first user-modifiable source code representing the ML model in a first coding language and a second user-modifiable source code representing the ML model in a second coding language different from the first coding language.

8. A computer-implemented method, comprising:
in response to receiving data indicating a machine-learning (ML) model at a frontend of a ML compiler, generating, by the ML compiler, an intermediate representation of the ML model based on a context in which the ML model is to be deployed;
modifying by the ML compiler, one or more operators of the intermediate representation to produce a transformed representation; and
generating user-modifiable source code representing the ML model based on the transformed representation.

9. The method of claim 8, further comprising:
compiling the user-modifiable source code representing the ML model into machine-readable code.

10. The method of claim 9, further comprising:
in response to executing an application including the machine-readable code, performing, by an acceleration unit, one or more operations for the ML model; and
generating one or more frames based on the acceleration unit performing the one or more operations.

11. The method of claim 8, wherein the context includes real-time graphics rendering.

12. The method of claim 11, wherein the user-modifiable source code is in a high-level shader language.

13. The method of claim 8, further comprising:
determining a plurality of operators and a plurality of tensors based on the data indicating the ML model, wherein the intermediate representation of the ML model indicates the plurality of operators and the plurality of tensors.

14. The method of claim 13, wherein modifying one or more operators of the intermediate representation includes modifying one or more data types.

15. The method of claim 13, further comprising:
fusing two or more operators of the plurality of operators to produce one or more fused operators, wherein the transformed representation indicates the one or more fused operators.

16. The method of claim 8, further comprising:
allocating one or more buffers to the one or more operators of the intermediate representation.

17. The method of claim 8, further comprising:
generating, by the ML compiler, a first user-modifiable source code representing the ML model in a first coding language and a second user-modifiable source code representing the ML model in a second coding language different from the first coding language.

18. A system, comprising:
one or more processors configured to implement a machine-learning (ML) compiler, wherein the one or more processors are configured to:
receive an ML file in a format of a plurality of formats supported by the ML compiler, wherein the ML file represents an ML model;
determining one or more operators and one or more tensors of the ML model based on the ML file and a context in which the ML model is to be deployed; and
generate user-modifiable source code representing the ML model based on the one or more operators and one or more tensors.

19. The system of claim 18, wherein the context includes real-time graphics rendering.

20. The system of claim 19, wherein the user-modifiable source code is in a high-level shader language.
